(19) United States
(12) Patent Application Publication
(10) Pub. No.: US 2017/0371611 A1
(43) Pub. Date: Dec. 28, 2017

(54) MULTI-DEVICE SYSTEM RUNNING A SINGLE OPERATING SYSTEM

(71) Applicant: JET OPTOELECTRONICS CO., LTD., TAIPEI CITY (TW)

(72) Inventors: HSING-HAO HUANG, TAIPEI CITY (TW); TAI-HAO WEN, TAIPEI CITY (TW)

(21) Appl. No.: 15/189,406

(22) Filed: Jun. 22, 2016

(51) Int. Cl. G06F 3/14; G09G 5/00; G09G 5/12

(52) U.S. Cl. CPC G06F 3/1431; G09G 5/12; G09G 5/006; G09G 2360/10; G09G 2360/04

(57) ABSTRACT

Disclosed is a multi-device system running a single operating system, which comprises a first device and a second device. The first device comprises a central processing unit (CPU), a first display unit and a first communication unit. The second device comprises a second communication unit, a microcontroller and a second display unit. The first display unit displays an interface for a first user to operate. Based on the data transmission between the first communication unit and the second communication unit, the CPU, via the microcontroller, indirectly drives the second display unit to display another interface for a second user to operate. According to the operations made by the first user and the second user, the first display unit and the second display unit respectively display different interfaces. From the first user's perspective and the second user's perspective, they are operating two independent operating systems.

### BACKGROUND OF THE INVENTION

### 1. Field of the Invention

The instant disclosure relates to a multi-device system; in particular, to a multi-device system that runs a single operating system where devices thereof can respectively be used by different users.

### 2. Description of Related Art

As technology develops, it is becoming more convenient for people to use applications through screen devices. Particularly, this kind of screen device is portable, such that people can use any application through their devices at hand anytime and anywhere. For example, the application may be a mail application, a messaging application, the calendar application, the browser, LINE™, WeChat™ or the like.

Nowadays, multi-device systems are widely used in many different places, such as the office, home and even vehicles, so that people can multitask at work, or enjoy videos and play games on different screen devices.

Currently, in most multi-device systems, each device needs to run its own operating system. Multi-device systems that run a single operating system can only be used by one user, but cannot be respectively used by different users.

### SUMMARY OF THE INVENTION

The instant disclosure provides a multi-device system comprising a plurality of devices. These devices run a single operating system, where only one of the devices needs to have the hardware capable of running the operating system. Herein, the term “central processing unit” is sometimes used to capture all the extra hardware needed to run an operating system as opposed to simpler programs that a microcontroller is capable of running Even though these devices run the same operating system, different devices can be used by different users respectively.

The multi-device system provided by the instant disclosure comprises a first device and a second device. The first device comprises a central processing unit, a first display unit and a first communication unit. The central processing unit runs a single operating system. The second device comprises a second communication unit, a microcontroller and a second display unit. The first display unit and the first communication unit are both electrically connected to the central processing unit. The central processing unit drives the first display unit to display an interface of the operating system for a first user to use. The first communication unit is connected to the second communication unit, and the microcontroller is electrically connected between the second display unit and the second communication unit. Through the data transmission between the first communication unit and the second communication unit, the central processing unit controls the microcontroller to drive the second display unit to display another interface of the operating system for a second user to use.

In this multi-device system, the first display unit of the first device and the second display unit of the second device respectively display different interfaces of the operating system according to the operations of the first user and those of the second user. One of the advantages of the instant disclosure is that only one central processing unit, capable of handling complex computations, is needed in one of the devices to run the operating system, and in this manner, the multi-device system can still show the correct user interface on each device's display such that different users can independently use different devices. Briefly, the multi-device system provided by the instant disclosure not only has a cost savings by only using one central processing unit, but allows different users to independently use different devices, which provides a flexibility for use.

For further understanding of the instant disclosure, please refer to the following detailed description illustrating the embodiments of the instant disclosure. The description is only for illustrating the instant disclosure, not for limiting the scope of the claim.

### BRIEF DESCRIPTION OF THE DRAWINGS

Embodiments are illustrated by way of example and not by way of limitation in the figures of the accompanying drawings, in which like references indicate similar elements and in which:

FIG. 1 shows a block diagram of a multi-device system running a single operating system of one embodiment of the instant disclosure.

FIG. 2 shows a block diagram of the operating system run by the multi-device system provided by the instant disclosure.

FIG. 3 shows a schematic diagram of a multi-device system running a single operating system of one embodiment of the instant disclosure.

### DETAILED DESCRIPTION OF PREFERRED EMBODIMENTS

The aforementioned illustrations and the following detailed descriptions are exemplary for the purpose of further explaining the scope of the instant disclosure. Other objectives and advantages related to the instant disclosure will be illustrated in the subsequent descriptions and appended drawings.

It will be understood that, although the terms first, second, third, and the like, may be used herein to describe various elements, these elements should not be limited by these terms. These terms are only to distinguish one element from another; region or section discussed below could be termed a second element without departing from the teachings of the instant disclosure. As used herein, the term “and/or” includes any and all combinations of one or more of the associated listed items.

[One Embodiment of the Multi-Device System]

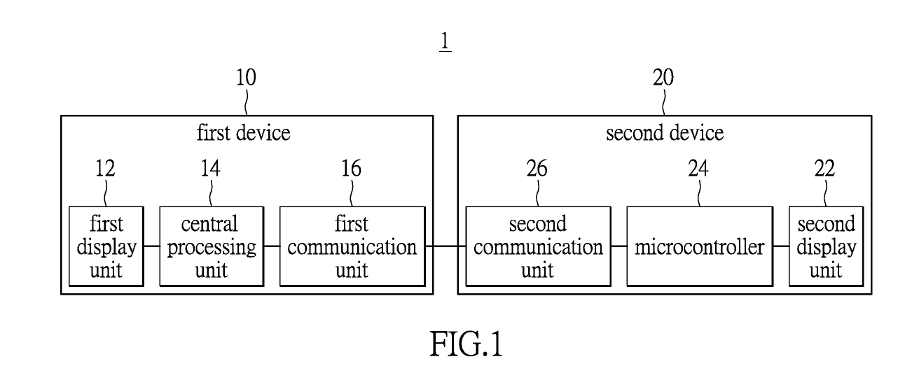

A multi-device system is provided in this embodiment, and is characterized in that different users can independently use different devices in this multi-device system. Refer to FIG. 1, which shows a block diagram of a multi-device system running a single operating system of one embodiment of the instant disclosure.

As shown in FIG. 1, the multi-device system 1 comprises a first device 10 and a second device 20, and the first device 10 and the second device 20 can transmit data to each other wirelessly or via wire. For example, the first device 10 and the second device 20 can transmit instructions to each other under the Wi-Fi communication protocol, or the first device 10 and the second device 20 can transmit audio and video signals through the wired multimedia serial link, but it is not limited herein. For ease of illustrating the instant disclosure, the multi-device system 1 only comprises a first device 10 and a second device 20, but the number of devices in the multi-device system 1 is not restricted herein.

The first device 10 comprises a first display unit 12, a central processing unit 14 and a first communication unit 16. The central processing unit 14 is electrically connected between the first display unit 12 and the first communication unit 16. Likewise, the second device 20 comprises a second display unit 22 and a second communication unit 26. However, unlike the first device 10, a microcontroller 24 is configured in the second device 20 instead of another central processing unit capable of running an operating system, and the microcontroller 24 is electrically connected between the second display unit 22 and the second communication unit 26.

Before illustrating details of the multi-device system 1, it is noted that in the following description, “image”, which is generated by the library, refers to all the pixel data that is displayed on screen. For example, if the screen resolution is 800×600, the screen has 480000 pixels, and the image that a user sees on the screen consists of the color data of each pixel. “Image data”, which is generated by an application, refers to calls to functions provided by the application framework and the library (e.g., If the application wants to draw a red circle with a radius of 25 at the coordinate 50, 100, it calls the corresponding function, which may be a “drawCircle( )”, to do it). “Desk image” refers to the initial user interface of the operating system displayed on screen when the device is turned on. “Device identifier” refers to a unique identifier of each device for identifying devices. For example, the device identifier can be an Internet protocol address (IP) or a unique identifier (UID) of a device, but it is not limited herein.

In addition, “event” refers to the data representing an action triggered by the user. Take a touch screen as an example of the first display unit 12. When a user taps the icon of an application on first display unit 12, the event comprises the coordinates of the tapped location. When the event travels through the system, the device ID may be added to the event so that it can be known where the event comes from. Also, the event may be converted to another form of data as it travels through the system. For example, the event may be converted to the calling of a callback function, and the framework calls the callback function corresponding to the application to run the application. When the user is operating an application and when the event gets to the application for the application to execute it, the device ID is no longer needed and may be removed. If first display unit 12 is not a touch screen, the user may use another means such as a mouse or a keyboard to interact with the screen, and a similar event is generated when the user clicks the mouse or presses the keyboard. Another example is when the user presses a physical button of a device, the data representing this action is generated so that the device knows that the physical button has been pressed and can act on it. But it is not limited herein. In short, an event describes an action triggered by the user, and the actual data it contains may change from one layer to the next layer in the operating system according to the layer's requirements.

The above terms will be used in the following description for describing the multi-device system 1 in this embodiment.

The central processing unit 14 in this embodiment runs a single operating system. When the first device 10 and the second device 20 are powered on but not used, the central processing unit 14 transmits a desk image generated by a launcher L to the first display unit 12, and drives the first display unit 12 to display it. Also, the central processing unit 14 transmits another desk image generated by the launcher L to the microcontroller 24 through the data transmission between the first communication unit 16 and the second communication unit 26. After that, the microcontroller 24 transmits the desk image to the second display unit 22 and drives the second display unit 22 to display it. It should be noted that, the desk images displayed by the first display unit 12 and the second display unit 22 are the desk images of the operating system run by the central processing unit 14 for a first user and a second user respectively.

According to operations of the first user and the second user, the first display unit 12 and the second display unit 22 can respectively display different user interfaces of the operating system. The first display unit 12 and the second display unit 22 may be, for example, touchscreens or common displays and it is not limited herein.

In this embodiment, the central processing unit 14 runs the operating system, and the microcontroller 24 simply transmits and receives data and drives the second display unit 22 to display the received data. The working mechanism about the central processing unit 14 and the microcontroller 24 is described as follows.

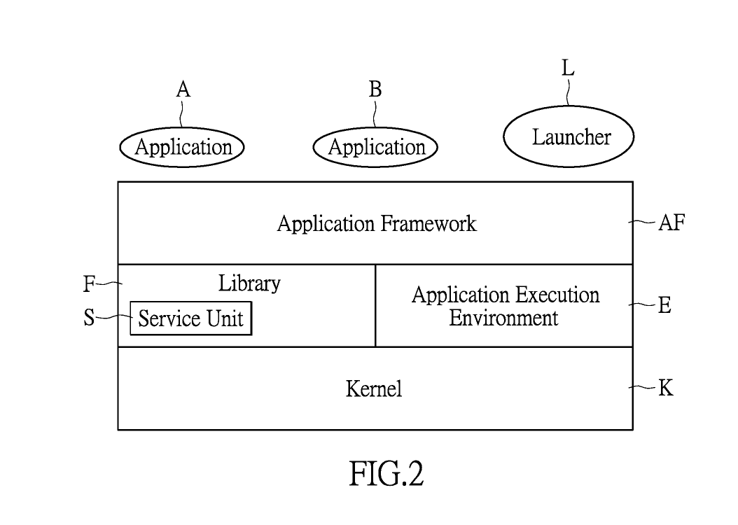

In conjunction with FIG. 1, FIG. 2 shows a block diagram of the operating system run by the multi-device system provided by the instant disclosure.

The software architecture of the operating system run by the multi-device system 1 is shown in FIG. 2. This operating system at least comprises a kernel K, a library F, an application execution environment E and an application framework AF. The library F at least comprises a service unit S. Application A, application B, and launcher L are applications built in accordance with the application framework AF. In addition, the library F and the application execution environment E are on top of the kernel K and under the application framework AF.

Application A refers to an application that is customized by programming and is characterized in that it can be chosen, started up and executed, and operated on different devices used by the first user and the second user respectively at the same time. Application A may be, for example, a map application, and the first user and the second user can use this application at same time. The first user may use this application to search for a landmark in Taiwan and the second user may search for a landmark in the United States; these two users can independently use this application simultaneously.

Specifically speaking, when the first user first uses the first device 10 and chooses application A by, for example, clicking the icon of application A displayed on the first display unit 12, application A is started up and executed for the first user to use. At this time, the second user can still use the second device 20 and choose application A by, for example, clicking the icon of application A displayed on the second display unit 22, and application A is started up and executed again for the second user to use. Likewise, when the second user first uses the second device 20 and chooses application A by, for example, clicking the icon of application A displayed on the second display unit 22, application A is started up and executed for the second user to use. At this time, the first user can still use the first device 10 and choose application A by, for example, clicking the icon of application A displayed by the first display unit 12, and application A is started up and executed again for the first user to use.

In other words, the launcher L can repeatedly start up the same application A, and the first user and the second user can execute and operate the same application A respectively on the first device 10 and the second device 20 based on different user identifications without interrupting each other.

On the other hand, as shown in FIG. 2, the application built in accordance with the application framework AF may be an application B. For an Android device, application B refers to an application initially installed in the device, such as the mail application, the messaging application, the calendar application, the browser, the contacts application or the like, or the applications that a user downloads from an application store, such as Google Play™, and installs in his device, such as LINE™, WeChat™ or the like.

The difference between application A and B is that application B cannot be respectively started up and executed by the first user and the second user on the first device 10 and the second device 20 simultaneously.

Specifically speaking, when no one chooses either application A or B on any display unit, both of the desk images displayed on the first display unit 12 and the second display unit 22 comprise icons of the applications A and B. Once the first user chooses application B on the first display unit 12, the icon of application B disappears on the second display unit 22. Once application B is started up by the first user, it cannot be repeatedly started up by the second user. On the other hand, once the second user chooses application B on the second display unit 22, the icon of application B disappears on the first display unit 12. Once application B is started up by the second user, it cannot be repeatedly started up by the first user.

In another embodiment, when the first user chooses application B on the first display unit 12, the icon of application B still shows on the second display unit 22, but once the second user chooses application B on the second display unit 22, the central processing unit 14 transmits an error message to the microcontroller 24 through the data transmission between the first communication unit 16 and the second communication unit 26. After that, the microcontroller 24 drives the second display unit 22 to display the error message. That is, if application B has been started up and executed by the first user on the first device 10, it cannot be repeatedly started up and executed by the second user on the second device 20. On the other hand, when the second user chooses application B on the second display unit 22, the icon of application B still shows on the first display unit 12, but once the first user chooses application B on the first display unit 12, the central processing unit 14 transmits an error message and drives the first display unit 12 to display the error message. That is, if application B has been started up and executed by the second user on the second device 20, it cannot be repeatedly started up and executed by the first user on the first device 10.

For ease of understanding, the Android system is taken as an example of the operating system in this embodiment, but it is not limited herein. For the Android system, the application execution environment E is the Android Runtime and the kernel K is the Linux Kernel. In addition, the library F comprises a plurality of functions for the application developers to use. In the Android system, when a device is turned on, the central processing unit 14 runs the operating system. The kernel K starts up the application execution environment E and the library F, the application execution environment E starts up the application framework AF, and the application framework AF starts up the launcher L. When a user chooses application A or B, the launcher L starts up the chosen application. When the application wants to perform an action, it calls the application framework AF, which calls the library F, and the library F executes the action. When the launcher L needs to perform an action, the launcher L calls the application framework AF, which calls the library F, and the library F executes the action.

In this embodiment, the launcher L is an application that is mainly used to start up application A or B, but actually the launcher L may also be used to switch between the home screen views, to provide a shortcut for an application, and to provide wallpaper and the like.

The following description is for illustrating how the application will be started up and executed by the multi-device system 1 after a user chooses one application. The difference between applications A and B has been described above, so the following description only illustrates how application A will be started up and executed by the multi-device system 1 after a user chooses application A.

When the first user chooses application A on the first display unit 12 by, for example, clicking the icon of application A, the first display unit 12 generates and transmits a first event to the central processing unit 14. When the second user chooses application A on the second display unit 12 by, for example, clicking the icon of application A, the second display unit 22 generates and transmits a first event to the microcontroller 24, and then the central processing unit 14 receives this first event through the data transmission between of the first communication unit 16 and the second communication unit 26.

The central processing unit 14 transmits the first event to the kernel K, the kernel K transmits the first event to the library F, the library F transmits the first event to the application framework AF, and the application framework AF transmits the first event to the launcher L. When the launcher L receives the first event, it learns application A has been chosen by the user according to the first event and thus starts up application A.

In the above described process where the launcher L starts up application A, the launcher L obtains an application identifier and a device identifier, and packets them into an instruction. This instruction is transmitted to the application framework AF. After receiving the instruction, the application framework AF executes application A and passes the instruction to the service unit S. When the service unit S receives the instruction, it records the mappings between the device identifiers and the application identifiers. The mappings tell you the corresponding application identifiers given a device identifier and the corresponding device identifier given an application identifier. One thing worth noting is that even if the same application runs on the first device 10 and on the second device 20 at the same time, they will have different application identifiers.

After that, application A generates and transmits a startup image data to the application framework AF. The application framework AF transmits the startup image data to the library F, and accordingly the library F generates a startup image. According to the mappings between the device identifiers and the application identifiers recorded by the service unit S, the library F learns which device is a target device that it needs to transmit the startup image to, and thus the library F transmits the startup image to the target device. If the target device is the first device 10, the library F transmits the startup image to the central processing unit 14, and the central processing unit 14 drives the first display unit 12 to display the startup image. If the target device is the second device 20, the library F transmits the startup image to the central processing unit 14. Through the data transmission between the first communication unit 16 and the second communication unit 26, the startup image is transmitted to the microcontroller 24, and the microcontroller 24 drives the second display unit 22 to display the startup image. At this point, the process of the multi-device system 1 starting up and executing application A has been completed. Here are some examples of what the startup image may look like. If application A is a game, the startup image may be the initial game screen where the user can select game options such as “Start”, “Setting”, or “Quit”. If application A is a map, the startup image may be a user interface that allows the user to enter an address.

The following description is for illustrating how an application is operated by the user in the multi-device system 1 after the application is started up. The difference between the applications A and B has been described above, so the following description only illustrates how application A will be operated by the user in the multi-device system 1 after the application is started up.

When application A has been started up by the launcher L and has been executed by the application framework AF, the startup image is displayed on the first display unit 12 or the second display unit 22, and the first user or the second user can start to operate application A.

When the first user clicks or touches anywhere in the startup image displayed on the first display unit 12 to operate application A, the first display unit 12 generates and transmits a second event to the central processing unit 14. When the second user clicks or touches anywhere in the startup image displayed on the second display unit 22 to operate application A, the second display unit 22 generates and transmits a second event to the microcontroller 24, and then the microcontroller 24 transmits the second event to the central processing unit 14 through data transmission between the first communication unit 16 and the second communication unit 26.

The central processing unit 14 transmits the second event to the kernel K, and the kernel K transmits the second event to the library F. The library F learns the device identifier from the second event, and passes the device identifier to the service unit S. Because the service unit S has previously recorded the mappings between the device identifiers and the application identifiers, the library F can learn from the service unit S which application A corresponds to this device identifier. When the library F learns which application A corresponds to this device identifier, the library F transmits the second event to application A through the application framework AF so that application A can execute the second event. Here is an example. Assume that application A is a game and the user presses a button inside application A. The action of pressing the button is captured by the second event, and application A executes the second event and generates an operation image data, as described below.

When application A executes the second event, application A generates and transmits an operation image data to the application framework AF. The application framework AF transmits the operation image data to the library F, and the library F generates an operation image. According to the mappings between the device identifiers and the application identifiers recorded by the service unit S, the library F learns which device is a target device that it needs to transmit the operation image to, and thus the library F transmits the operation image to the target device. If the target device is the first device 10, the library F transmits the operation image to the central processing unit 14, and the central processing unit 14 drives the first display unit 12 to display the operation image. If the target device is the second device 20, the library F transmits the operation image to the central processing unit 14. Through the data transmission between the first communication unit 16 and the second communication unit 26, the operation image is transmitted to the microcontroller 24, and the microcontroller 24 drives the second display unit 22 to display the operation image. At this point, the process of the user operating the application A in the multi-device system 1 has been completed. When the user performs another action with application A, the same process repeats.

An important feature of the multi-device system 1 is that it can correctly determine which device should display which application with a single operating system with only one device having the central processing unit 14 such that multiple users can independently operate multiple devices in a single operating system.

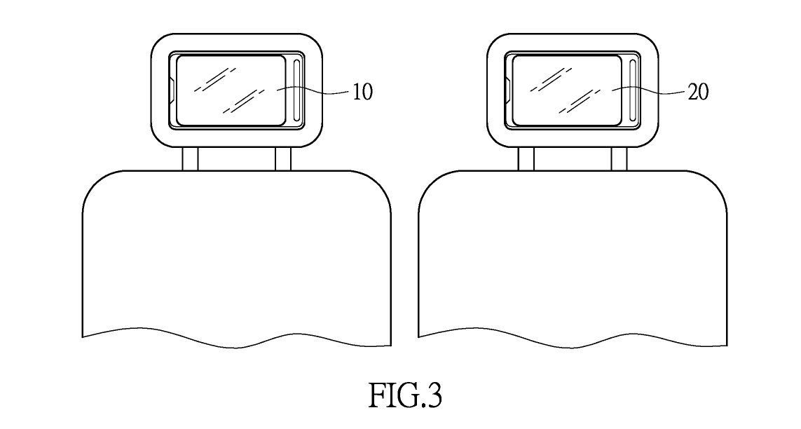

FIG. 3 shows a schematic diagram of a multi-device system running a single operating system of one embodiment of the instant disclosure. As shown in FIG. 3, the multi-device system 1 can be, for example, installed in a vehicle. The first device 10 and second device 20 are, for example, configured in the back of the headrests of the front seats. In this manner, the first user and the second user in the back seats can independently use the first device 10 and the second device 20. In addition to the convenience that different users can independently use different devices, because only one of the first device 10 and the second device 20 needs to have hardware that can run an operating system, there is also a cost savings for the entire system.

To sum up, the multi-device system provided by this instant disclosure at least has the following advantages:

First, only one of the devices in the multi-device system needs to run the one operating system for processing instructions from and for devices. Compared to the multi-device systems that require two or more devices to run their own operating systems, the instant disclosure has a cost savings.

Moreover, only one of devices in the multi-device system runs the operating system, but different users can independently use the same application on their own device, which provides great flexibility.

The descriptions illustrated supra set forth simply the preferred embodiments of the instant disclosure; however, the characteristics of the instant disclosure are by no means restricted thereto. All changes, alterations, or modifications conveniently considered by those skilled in the art are deemed to be encompassed within the scope of the instant disclosure delineated by the following claims.

1. A multi-device system running a single operating system, comprising:
a first device, comprising:
a central processing unit, running the operating system;
a first display unit, electrically connected to the central processing unit, displaying an image of the operating system for a first user to operate; and
a first communication unit, electrically connected to the central processing unit;
a second device, comprising:
a second communication unit, electrically connected to the first communication unit;
a microcontroller, electrically connected to the second communication unit; and
a second display unit, electrically connected to the microcontroller, the central processing unit driving the microcontroller to control the second display unit to display the image of the operating system through the data transmission between the first communication unit and the second communication unit for a second user to operate;
wherein the first display unit and the second display unit respectively display different images of the operating system according to the operations of the first user and the second user;
wherein the operating system comprises a kernel, a library, an application execution environment and an application framework, wherein a plurality of applications are built in accordance with the application framework and at least one of the applications is a launcher.

2. (canceled)

3. (canceled)

4. The multi-device system according to claim 1, wherein the operating system is an Android operating system.

5. The multi-device system according to claim 1,
wherein the library at least comprises a service unit;
wherein the first display unit or the second display unit generates and transmits a first event to the central processing unit when the first user or the second user chooses one of the applications on the first display unit or the second display unit, the central processing unit transmits the first event to the kernel, the kernel transmits the first event to the library, the library transmits the first event to the application framework, the application framework transmits the first event to the launcher, and the launcher starts up the application according to the first event and transmits an instruction to the application framework, and the application framework executes the application and the launcher passes the instruction to the service unit, wherein the instruction comprises an application identifier and a device identifier; and
wherein the application identifier corresponds to the chosen application, the device identifier corresponds to the first device or the second device, and the service unit records the mapping between the application identifier and the device identifier in the instruction.

6. The multi-device system according to claim 5, wherein when the first user chooses one of the applications on the first display unit, the started-up and executed application generates and transmits a startup image data to the application framework, the application framework transmits the startup image data to the library for generating a startup image, the library transmits the startup image to the central processing unit, and the central processing unit drives the first display unit to display the startup image.

7. The multi-device system according to claim 6, wherein after the application is started up and executed, when the first user operates the application, the first display unit generates and transmits a second event to the central processing unit, the central processing unit transmits the second event to the kernel, the kernel transmits the second event to the library, and the library transmits the second event to the corresponding application through the application framework according to the recorded mapping between the application identifier and the device identifier, and the application executes the second event.

8. The multi-device system according to claim 7, wherein after the application executes the second event, the application generates and transmits an operation image data to the application framework, the application framework transmits the operation image data to the library to generate an operation image, the library transmits the operation image to the central processing unit according to the recorded mapping between the application identifier and the device identifier, and the central processing unit drives the first display unit to display the operation image.

9. The multi-device system according to claim 5, wherein when the second user chooses one of the applications on the second display unit, the microcontroller transmits the first event generated by the second display unit to the central processing unit through the data transmission between the first communication unit and the second communication unit, and the chosen application is started up and executed, wherein the device identifier in the instruction corresponds to the second device.

10. The multi-device system according to claim 9, wherein the started up and executed application generates and transmits a startup image data to the application framework, the application framework transmits the startup image data to the library to generate a startup image, and according to the device identifier, the library transmits the startup image to the central processing unit and the startup image is transmitted to the microcontroller through the data transmission between the first communication unit and the second communication unit, and the microcontroller controls the second display unit to display the startup image.

11. The multi-device system according to claim 10, wherein after the application is started up and executed, when the second user operates the application on the second display unit, the second display unit generates and transmits a second event to the central processing unit, the central processing unit transmits the second event to the kernel, the kernel transmits the second event to the library, the library transmits the second event to the corresponding application through the application framework according to the recorded mapping between the application identifier and the device identifier, and the application executes the second event.

12. The multi-device system according to claim 11, wherein after the application executes the second event, the application generates and transmits an operation image data to the application framework, the application framework transmits the operation image data to the library to generate an operation image, according to the recorded mapping between the application identifier and the device identifier, the library transmits the operation image to the central processing unit, and the operation image is transmitted to the microcontroller through the data transmission between the first communication unit and the second communication unit, and the microcontroller controls the second display unit to display the operation image.
